(19) United States
(12) Patent Application Publication
(10) Pub. No.: US 2026/0286487 A1
(43) Pub. Date: Sep. 24, 2026

(54) ALLOY COMPOSITIONS AND ARTICLES FORMED OF SUCH COMPOSITIONS

(71) Applicant: GE Infrastructure Technology LLC, Greenville, SC (US)

(72) Inventor: Theodore Francis Majka, Simpsonville, SC (US)

(21) Appl. No.: 19/082,955

(22) Filed: Mar. 18, 2025

(51) Int. Cl. C22C 38/52; C22C 38/00; C22C 38/02; C22C 38/04; C22C 38/06; C22C 38/14; C22C 38/42; C22C 38/44; C22C 38/48; F01D 5/28; F01D 25/24

(52) U.S. Cl. CPC C22C 38/52; C22C 38/001; C22C 38/002; C22C 38/02; C22C 38/04; C22C 38/06; C22C 38/14; C22C 38/42; C22C 38/44; C22C 38/48; F01D 5/28; F01D 25/24; F05D 2300/171; F05D 2300/506

(57) ABSTRACT

Described herein are compositions, and more particularly to alloy compositions and articles formed with the alloy compositions. The alloy compositions are broadly applicable in applications requiring alloys with at least one of improved hardness stability, improved Charpy performance, and improved creep strength at higher operating temperatures.

### BACKGROUND

The field of the disclosure relates generally to compositions, and more particularly to alloy compositions and articles formed with the alloy compositions. The alloy compositions are broadly applicable in applications requiring alloys with at least one of improved hardness stability, improved Charpy performance, and improved creep strength.

Iron-based alloys are commonly used in cast and wrought steel products. However, at higher operating temperatures, such as temperatures experienced for a midshaft of a turbine, conventional iron-based alloys exhibit instability and poor long-term rupture characteristics such as creep strength. To mitigate property losses, lower operating temperatures are recommended with such iron-based alloys. Such lower operating temperatures are incompatible with many steam turbine applications. Cooling air may also be utilized to keep the part temperature at an acceptable level, however, this cooling air is an added cost and results in loss of efficiency turbines (e.g., gas turbines).

Accordingly, there is a need for iron-based alloys that possess with at least one of improved hardness stability, improved Charpy performance, and improved creep strength at higher operating temperatures.

### BRIEF DESCRIPTION

In one aspect, a composition is provided. The composition includes from about 0.12 wt % to about 0.23 wt % carbon, from about 0.2 wt % to about 0.6 wt % manganese, from about 0.1 wt % to about 0.3 wt % silicon, from about 7.0 wt % to about 9.0 wt % chromium, from about 0.5 wt % to about 0.9 wt % nickel, from about 1.8 wt % to about 2.4 wt % molybdenum, from about 2.0 wt % to about 2.6 wt % tungsten, from about 3.5 wt % to about 4.5 wt % cobalt, from about 0.8 wt % to about 1.2 wt % copper, from about 0.5 wt % to about 0.8 wt % niobium, from about 0.005 wt % to about 0.025 wt % nitrogen, from about 0.05 wt % to about 0.20 wt % aluminum, from about 0.05 wt % to about 0.25 wt % titanium, from about 0.4 wt % to about 0.8 wt % tantalum, from about 0.005 wt % to about 0.025 wt % boron, and iron.

In another aspect, an article including a composition is provided. The composition includes from about 0.12 wt % to about 0.23 wt % carbon, from about 0.2 wt % to about 0.6 wt % manganese, from about 0.1 wt % to about 0.3 wt % silicon, from about 7.0 wt % to about 9.0 wt % chromium, from about 0.5 wt % to about 0.9 wt % nickel, from about 1.8 wt % to about 2.4 wt % molybdenum, from about 2.0 wt % to about 2.6 wt % tungsten, from about 3.5 wt % to about 4.5 wt % cobalt, from about 0.8 wt % to about 1.2 wt % copper, from about 0.5 wt % to about 0.8 wt % niobium, from about 0.005 wt % to about 0.025 wt % nitrogen, from about 0.05 wt % to about 0.20 wt % aluminum, from about 0.05 wt % to about 0.25 wt % titanium, from about 0.4 wt % to about 0.8 wt % tantalum, from about 0.005 wt % to about 0.025 wt % boron, and iron.

In another aspect, a composition is provided. The composition includes from about 0.20 wt % to about 0.28 wt % carbon, from about 0.3 wt % to about 0.6 wt % manganese, from about 0.05 wt % to about 0.20 wt % silicon, from about 10.0 wt % to about 11.0 wt % chromium, from about 0.3 wt % to about 0.7 wt % nickel, from about 1.35 wt % to about 1.65 wt % molybdenum, from about 1.3 wt % to about 1.6 wt % tungsten, from about 0.85 wt % to about 1.15 wt % cobalt, from about 0.85 wt % to about 1.15 wt % copper, from about 0.25 wt % to about 0.35 wt % niobium, from about 0.05 wt % to about 0.10 wt % nitrogen, from about 0.03 wt % to about 0.07 wt % tantalum, from about 0.20 wt % to about 0.30 wt % vanadium, and iron.

In another aspect, an article including a composition is provided. The composition includes from about 0.20 wt % to about 0.28 wt % carbon, from about 0.3 wt % to about 0.6 wt % manganese, from about 0.05 wt % to about 0.20 wt % silicon, from about 10.0 wt % to about 11.0 wt % chromium, from about 0.3 wt % to about 0.7 wt % nickel, from about 1.35 wt % to about 1.65 wt % molybdenum, from about 1.3 wt % to about 1.6 wt % tungsten, from about 0.85 wt % to about 1.15 wt % cobalt, from about 0.85 wt % to about 1.15 wt % copper, from about 0.25 wt % to about 0.35 wt % niobium, from about 0.05 wt % to about 0.10 wt % nitrogen, from about 0.03 wt % to about 0.07 wt % tantalum, from about 0.20 wt % to about 0.30 wt % vanadium, and iron.

In yet another aspect, a composition is provided. The composition includes from about 0.16 wt % to about 0.24 wt % carbon, from about 0.4 wt % to about 0.8 wt % manganese, from about 0.10 wt % to about 0.30 wt % silicon, from about 9.5 wt % to about 11.0 wt % chromium, from about 0.3 wt % to about 0.7 wt % nickel, from about 2.0 wt % to about 2.8 wt % molybdenum, from about 1.2 wt % to about 2.0 wt % tungsten, from about 3.7 wt % to about 4.3 wt % cobalt, from about 1.1 wt % to about 1.5 wt % copper, from about 0.35 wt % to about 0.55 wt % niobium, from about 0.005 wt % to about 0.025 wt % nitrogen, from about 0.20 wt % to about 0.40 wt % tantalum, from about 0.01 wt % to about 0.05 wt % aluminum, from about 0.005 wt % to about 0.025 wt % boron, and iron.

In another aspect, an article including a composition is provided. The composition includes from about 0.16 wt % to about 0.24 wt % carbon, from about 0.4 wt % to about 0.8 wt % manganese, from about 0.10 wt % to about 0.30 wt % silicon, from about 9.5 wt % to about 11.0 wt % chromium, from about 0.3 wt % to about 0.7 wt % nickel, from about 2.0 wt % to about 2.8 wt % molybdenum, from about 1.2 wt % to about 2.0 wt % tungsten, from about 3.7 wt % to about 4.3 wt % cobalt, from about 1.1 wt % to about 1.5 wt % copper, from about 0.35 wt % to about 0.55 wt % niobium, from about 0.005 wt % to about 0.025 wt % nitrogen, from about 0.20 wt % to about 0.40 wt % tantalum, from about 0.01 wt % to about 0.05 wt % aluminum, from about 0.005 wt % to about 0.025 wt % boron, and iron.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 depicts stress rupture testing for a comparative composition and compositions in accordance with the present disclosure;

FIG. 2 depicts creep testing for a comparative composition and compositions in accordance with the present disclosure; and

FIG. 3 depicts Charpy testing for a comparative composition and compositions in accordance with the present disclosure.

### DETAILED DESCRIPTION

It was discovered herein that compositions according to the present disclosure could be used for wrought and cast alloys. The compositions include altered elemental content compared to other alloy compositions. Compositions according to the present disclosure are broadly applicable in applications requiring alloys possessing at least one of improved hardness stability, improved Charpy performance, and improved creep strength at higher operating temperatures.

Compositions according to the present disclosure were discovered by producing 150 different iron-based alloy compositions and analyzing these compositions to determine their corresponding properties. The compositions according to the present disclosure include elemental content resulting in optimized properties.

### First Alloy Composition.

The embodiments described herein overcome at least some of the disadvantages of known iron-based alloys. The exemplary embodiments described herein include a composition. The composition includes from about 0.12 wt % to about 0.23 wt % carbon, from about 0.2 wt % to about 0.6 wt % manganese, from about 0.1 wt % to about 0.3 wt % silicon, from about 7.0 wt % to about 9.0 wt % chromium, from about 0.5 wt % to about 0.9 wt % nickel, from about 1.8 wt % to about 2.4 wt % molybdenum, from about 2.0 wt % to about 2.6 wt % tungsten, from about 3.5 wt % to about 4.5 wt % cobalt, from about 0.8 wt % to about 1.2 wt % copper, from about 0.5 wt % to about 0.8 wt % niobium, from about 0.005 wt % to about 0.025 wt % nitrogen, from about 0.05 wt % to about 0.20 wt % aluminum, from about 0.05 wt % to about 0.25 wt % titanium, from about 0.4 wt % to about 0.8 wt % tantalum, from about 0.005 wt % to about 0.025 wt % boron, and iron.

In some embodiments, the composition may include any suitable amount of carbon (C) that facilitates the composition described herein. In some embodiments, the composition includes from about 0.12 wt % to about 0.23 wt % carbon. In some embodiments, the composition includes from about 0.15 wt % to about 0.20 wt % carbon.

In some embodiments, the composition includes at least about 0.12 wt % C, at least about 0.13 wt % C, at least about 0.14 wt % C, at least about 0.15 wt % C, at least about 0.16 wt % C, at least about 0.17 wt % C, at least about 0.18 wt % C, at least about 0.19 wt % C, at least about 0.20 wt % C, at least about 0.21 wt % C, or at least about 0.22 wt % C. In some embodiments, the composition includes at most about 0.13 wt % C, at most about 0.14 wt % C, at most about 0.15 wt % C, at most about 0.16 wt % C, at most about 0.17 wt % C, at most about 0.18 wt % C, at most about 0.19 wt % C, at most about 0.20 wt % C, at most about 0.21 wt % C, at most about 0.22 wt % C, or at most about 0.23 wt % C.

In some embodiments, the composition may include any suitable amount of manganese (Mn) that facilitates the composition described herein. In some embodiments, the composition includes from about 0.2 wt % to about 0.6 wt % manganese. In some embodiments, the composition includes from about 0.3 wt % to about 0.5 wt % manganese.

In some embodiments, the composition includes at least about 0.20 wt % Mn, at least about 0.25 wt % Mn, at least about 0.30 wt % Mn, at least about 0.35 wt % Mn, at least about 0.40 wt % Mn, at least about 0.45 wt % Mn, at least about 0.50 wt % Mn, or at least about 0.55 wt % Mn. In some embodiments, the composition includes at most about 0.25 wt % Mn, at most about 0.30 wt % Mn, at most about 0.35 wt % Mn, at most about 0.40 wt % Mn, at most about 0.45 wt % Mn, at most about 0.50 wt % Mn, at most about 0.55 wt % Mn, or at most about 0.60 wt % Mn.

In some embodiments, the composition may include any suitable amount of silicon (Si) that facilitates the composition described herein. In some embodiments, the composition includes from about 0.1 wt % to about 0.3 wt % silicon. In some embodiments, the composition includes from about 0.15 wt % to about 0.25 wt % silicon.

In some embodiments, the composition includes at least about 0.10 wt % Si, at least about 0.15 wt % Si, at least about 0.20 wt % Si, or at least about 0.25 wt % Si. In some embodiments, the composition includes at most about 0.15 wt % Si, at most about 0.20 wt % Si, at most about 0.25 wt % Si, or at most about 0.30 wt % Si.

In some embodiments, the composition may include any suitable amount of chromium (Cr) that facilitates the composition described herein. In some embodiments, the composition includes Cr. In some embodiments, the composition includes from about 7.0 wt % to about 9.0 wt % chromium. In some embodiments, the composition includes from about 7.5 wt % to about 8.5 wt % chromium.

In some embodiments, the composition includes at least about 7.0 wt % Cr, at least about 7.1 wt % Cr, at least about 7.2 wt % Cr, at least about 7.3 wt % Cr, at least about 7.4 wt % Cr, at least about 7.5 wt % Cr, at least about 7.6 wt % Cr, at least about 7.7 wt % Cr, at least about 7.8 wt % Cr, at least about 7.9 wt % Cr, 8.0 wt % Cr, at least about 8.1 wt % Cr, at least about 8.2 wt % Cr, at least about 8.3 wt % Cr, at least about 8.4 wt % Cr, at least about 8.5 wt % Cr, at least about 8.6 wt % Cr, at least about 8.7 wt % Cr, at least about 8.8 wt % Cr, or at least about 8.9 wt % Cr. In some embodiments, the composition includes at most about 7.1 wt % Cr, at most about 7.2 wt % Cr, at most about 7.3 wt % Cr, at most about 7.4 wt % Cr, at most about 7.5 wt % Cr, at most about 7.6 wt % Cr, at most about 7.7 wt % Cr, at most about 7.8 wt % Cr, at most about 7.9 wt % Cr, 8.0 wt % Cr, at most about 8.1 wt % Cr, at most about 8.2 wt % Cr, at most about 8.3 wt % Cr, at most about 8.4 wt % Cr, at most about 8.5 wt % Cr, at most about 8.6 wt % Cr, at most about 8.7 wt % Cr, at most about 8.8 wt % Cr, at most about 8.9 wt % Cr, or at most about 9.0 wt % Cr.

In some embodiments, the composition may include any suitable amount of nickel (Ni) that facilitates the composition described herein. In some embodiments, the composition includes from about 0.5 wt % to about 0.9 wt % nickel. In some embodiments, the composition includes from about 0.6 wt % to about 0.8 wt % nickel.

In some embodiments, the composition includes at least about 0.50 wt % Ni, at least about 0.55 wt % Ni, at least about 0.60 wt % Ni, at least about 0.65 wt % Ni, at least about 0.70 wt % Ni, at least about 0.75 wt % Ni, at least about 0.80 wt % Ni, or at least about 0.85 wt % Ni. In some embodiments, the composition includes at most about 0.55 wt % Ni, at most about 0.60 wt % Ni, at most about 0.65 wt % Ni, at most about 0.70 wt % Ni, at most about 0.75 wt % Ni, at most about 0.80 wt % Ni, at most about 0.85 wt % Ni, or at most about 0.90 wt % Ni.

In some embodiments, the composition may include any suitable amount of molybdenum (Mo) that facilitates the composition described herein. In some embodiments, the composition includes from about 1.8 wt % to about 2.4 wt % molybdenum. In some embodiments, the composition includes from about 2.0 wt % to about 2.2 wt % molybdenum.

In some embodiments, the composition includes at least about 1.8 wt % Mo, at least about 1.9 wt % Mo, at least about 2.0 wt % Mo, at least about 2.1 wt % Mo, at least about 2.2 wt % Mo, or at least about 2.3 wt % Mo. In some embodiments, the composition includes at most about 1.9 wt % Mo, at most about 2.0 wt % Mo, at most about 2.1 wt % Mo, at most about 2.2 wt % Mo, at most about 2.3 wt % Mo, or at most about 2.4 wt % Mo.

In some embodiments, the composition may include any suitable amount of tungsten (W) that facilitates the composition described herein. In some embodiments, the composition includes from about 2.0 wt % to about 2.6 wt % tungsten. In some embodiments, the composition includes from about 2.2 wt % to about 2.4 wt % tungsten.

In some embodiments, the composition includes at least about 2.0 wt % W, at least about 2.1 wt % W, at least about 2.2 wt % W, at least about 2.3 wt % W, at least about 2.4 wt % W, or at least about 2.5 wt % W. In some embodiments, the composition includes at most about 2.1 wt % W, at most about 2.2 wt % W, at most about 2.3 wt % W, at most about 2.4 wt % W, at most about 2.5 wt % W, or at most about 2.6 wt % W.

In some embodiments, the composition may include any suitable amount of cobalt (Co) that facilitates the composition described herein. In some embodiments, the composition includes from about 3.5 wt % to about 4.5 wt % cobalt. In some embodiments, the composition includes from about 3.9 wt % to about 4.1 wt % cobalt.

In some embodiments, the composition includes at least about 3.5 wt % Co, at least about 3.6 wt % Co, at least about 3.7 wt % Co, at least about 3.8 wt % Co, at least about 3.9 wt % Co, at least about 4.0 wt % Co, at least about 4.1 wt % Co, at least about 4.2 wt % Co, at least about 4.3 wt % Co, or at least about 4.4 wt % Co. In some embodiments, the composition includes at most about 3.6 wt % Co, at most about 3.7 wt % Co, at most about 3.8 wt % Co, at most about 3.9 wt % Co, at most about 4.0 wt % Co, at most about 4.1 wt % Co, at most about 4.2 wt % Co, at most about 4.3 wt % Co, at most about 4.4 wt % Co, or at most about 4.5 wt % Co.

In some embodiments, the composition may include any suitable amount of copper (Cu) that facilitates the composition described herein. In some embodiments, the composition includes from about 0.8 wt % to about 1.2 wt % copper. In some embodiments, the composition includes from about 0.9 wt % to about 1.1 wt % copper.

In some embodiments, the composition includes at least about 0.80 wt % Cu, at least about 0.85 wt % Cu, at least about 0.90 wt % Cu, at least about 0.95 wt % Cu, at least about 1.0 wt % Cu, at least about 1.05 wt % Cu, at least about 1.1 wt % Cu, or at least about 1.15 wt % Cu. In some embodiments, the composition includes at most about 0.85 wt % Cu, at most about 0.90 wt % Cu, at most about 0.95 wt % Cu, at most about 1.0 wt % Cu, at most about 1.05 wt % Cu, at most about 1.1 wt % Cu, at most about 1.15 wt % Cu, or at most about 1.2 wt % Cu.

In some embodiments, the composition may include any suitable amount of niobium (Nb) that facilitates the composition described herein. In some embodiments, the composition includes from about 0.5 wt % to about 0.8 wt % niobium. In some embodiments, the composition includes from about 0.6 wt % to about 0.7 wt % niobium.

In some embodiments, the composition includes at least about 0.50 wt % Nb, at least about 0.55 wt % Nb, at least about 0.60 wt % Nb, at least about 0.65 wt % Nb, at least about 0.70 wt % Nb, or at least about 0.75 wt % Nb. In some embodiments, the composition includes at most about 0.55 wt % Nb, at most about 0.60 wt % Nb, at most about 0.65 wt % Nb, at most about 0.70 wt % Nb, at most about 0.75 wt % Nb, or at most about 0.80 wt % Nb.

In some embodiments, the composition may include any suitable amount of nitrogen (N) that facilitates the composition described herein. In some embodiments, the composition includes from about 0.005 wt % to about 0.025 wt % nitrogen. In some embodiments, the composition includes from about 0.005 wt % to about 0.015 wt % nitrogen.

In some embodiments, the composition includes at least about 0.005 wt % N, at least about 0.01 wt % N, at least about 0.015 wt % N, or at least about 0.02 wt % N. In some embodiments, the composition includes at most about 0.01 wt % N, at most about 0.015 wt % N, at most about 0.02 wt % N, or at most about 0.025 wt % N.

In some embodiments, the composition may include any suitable amount of aluminum (Al) that facilitates the composition described herein. In some embodiments, the composition includes from about 0.05 wt % to about 0.20 wt % aluminum. In some embodiments, the composition includes from about 0.05 wt % to about 0.15 wt % aluminum.

In some embodiments, the composition includes at least about 0.05 wt % Al, at least about 0.10 wt % Al, or at least about 0.15 wt % Al. In some embodiments, the composition includes at most about 0.10 wt % Al, at most about 0.15 wt % Al, or at most about 0.20 wt % Al.

In some embodiments, the composition may include any suitable amount of titanium (Ti) that facilitates the composition described herein. In some embodiments, the composition includes from about 0.05 wt % to about 0.25 wt % titanium. In some embodiments, the composition includes from about 0.10 wt % to about 0.20 wt % titanium.

In some embodiments, the composition includes at least about 0.05 wt % Ti, at least about 0.10 wt % Ti, at least about 0.15 wt % Ti, or at least about 0.20 wt % Ti. In some embodiments, the composition includes at most about 0.10 wt % Ti, at most about 0.15 wt % Ti, at most about 0.20 wt % Ti, or at most about 0.25 wt % Ti.

In some embodiments, the composition may include any suitable amount of tantalum (Ta) that facilitates the composition described herein. In some embodiments, the composition includes from about 0.4 wt % to about 0.8 wt % tantalum. In some embodiments, the composition includes from about 0.55 wt % to about 0.65 wt % tantalum.

In some embodiments, the composition includes at least about 0.40 wt % Ta, at least about 0.45 wt % Ta, at least about 0.50 wt % Ta, at least about 0.55 wt % Ta, at least about 0.60 wt % Ta, at least about 0.65 wt % Ta, at least about 0.70 wt % Ta, or at least about 0.75 wt % Ta. In some embodiments, the composition includes at most about 0.45 wt % Ta, at most about 0.50 wt % Ta, at most about 0.55 wt % Ta, at most about 0.60 wt % Ta, at most about 0.65 wt % Ta, at most about 0.70 wt % Ta, at most about 0.75 wt % Ta, or at most about 0.80 wt % Ta.

In some embodiments, the composition may include any suitable amount of boron (B) that facilitates the composition described herein. In some embodiments, the composition includes from about 0.005 wt % to about 0.025 wt % boron. In some embodiments, the composition includes from about 0.005 wt % to about 0.015 wt % boron.

In some embodiments, the composition includes at least about 0.005 wt % B, at least about 0.010 wt % B, at least about 0.015 wt % B, or at least about 0.020 wt % B. In some embodiments, the composition includes at most about 0.010 wt % B, at most about 0.015 wt % B, at most about 0.020 wt % B, or at most about 0.025 wt % B.

In some embodiments, the composition may include any suitable amount of iron (Fe) that facilitates the composition described herein. In many embodiments, the composition includes balance iron. In these embodiments, the amount of iron is sufficient to bring the total weight percent of the composition to 100 wt %.

In some embodiments, the composition includes at least about 76 wt % Fe, at least about 77 wt % Fe, at least about 78 wt % Fe, at least about 79 wt % Fe, at least about 80 wt % Fe, at least about 81 wt % Fe, at least about 82 wt % Fe, or at least about 83 wt % Fe. In some embodiments, the composition includes at most about 77 wt % Fe, at most about 78 wt % Fe, at most about 79 wt % Fe, at most about 80 wt % Fe, at most about 81 wt % Fe, at most about 82 wt % Fe, at most about 83 wt % Fe, or at most about 84 wt % Fe.

In some embodiments, the composition may include tramp elements. As used herein, tramp elements include elements that may be inherently present in the composition and substantially alter the material properties of the composition. In some embodiments, tramp elements are not necessary in the composition and provide no benefit to the composition.

In some embodiments, the composition includes balance iron and residual elements. As used herein, residual elements include elements that may be inherently present in the composition but do not substantially alter the material properties of the composition if appropriately limited.

In these embodiments, the amount of iron and residual elements is sufficient to bring the total weight percent of the composition to 100 wt %.

In some embodiments, the composition further comprises a coating. In some embodiments, the composition further comprises a coating selected from the group consisting of nickel-cadmium coatings, phosphate-aluminum coatings, and combinations thereof.

In some embodiments, the composition exhibits a stress rupture duration of at least 35 hours when exposed to 62 ksi at 1050° F. In some embodiments, the composition exhibits a stress rupture duration of at least 100 hours when exposed to 62 ksi at 1050° F. In some embodiments, the composition exhibits a stress rupture duration of at least 350 hours when exposed to 62 ksi at 1050° F.

In some embodiments, the composition exhibits less than 5% creep deformation for at least 200 hours when exposed to 60 ksi at 1050° F. In some embodiments, the composition exhibits less than 5% creep deformation for at least 400 hours when exposed to 60 ksi at 1050° F. In some embodiments, the composition exhibits less than 5% creep deformation for at least 800 hours when exposed to 60 ksi at 1050° F.

In some embodiments, the composition exhibits a hardness loss of less than 4 HRC when exposed to 1050° F. for 1000 hours. In some embodiments, the composition exhibits a hardness loss of less than 2 HRC when exposed to 1050° F. for 1000 hours.

In some embodiments, the composition is an alloy composition. In some embodiments, the composition is a wrought composition, a forged composition, and/or a cast composition.

Also described herein is an article including the composition. Generally, the composition may be included in any suitable article known in the art that facilitates the use of the composition described herein.

In some embodiments, the article is produced using, but not limited to only using, a wrought process, a forge process, and/or a cast process. In some embodiments, the article is produced using a cast process.

In some embodiments, the article is a component of a turbine. In some embodiments, the turbine is a gas turbine or a steam turbine.

In some embodiments, the article is a component of a turbine such as, but not limited to only being, a nozzle, a shroud, a splash plate, a combustor component, a diffuser case, an inner diffuser case, a compressor case, an inner compressor case, a splitter, an inner barrel, a turbine shell, compressor blades, compressor vanes, guide vanes, retaining rings, and a combination thereof.

In some embodiments, the article is a component of a turbine such as, but not limited to only being, an inner casing for an in-case steam turbine high pressure rotor, an inner casing for an in-case steam turbine intermediate pressure rotor, an outer casing for an in-case steam turbine high pressure rotor, an outer casing for an in-case steam turbine intermediate pressure rotor, a packing head, a diaphragm casing, and a combination thereof.

In some embodiments, the article is a component of a turbo charger component. In some embodiments, the article is a component of an automobile.

Further aspects of the present disclosure are provided by the subject matter of the following clauses:
1. A composition comprising:
from about 0.12 wt % to about 0.23 wt % carbon;
from about 0.2 wt % to about 0.6 wt % manganese;
from about 0.1 wt % to about 0.3 wt % silicon;
from about 7.0 wt % to about 9.0 wt % chromium;
from about 0.5 wt % to about 0.9 wt % nickel;
from about 1.8 wt % to about 2.4 wt % molybdenum;
from about 2.0 wt % to about 2.6 wt % tungsten;
from about 3.5 wt % to about 4.5 wt % cobalt;
from about 0.8 wt % to about 1.2 wt % copper;
from about 0.5 wt % to about 0.8 wt % niobium;
from about 0.005 wt % to about 0.025 wt % nitrogen;
from about 0.05 wt % to about 0.20 wt % aluminum;
from about 0.05 wt % to about 0.25 wt % titanium;
from about 0.4 wt % to about 0.8 wt % tantalum;
from about 0.005 wt % to about 0.025 wt % boron; and
iron.
2. The composition according to the preceding clause, comprising:
from about 0.15 wt % to about 0.2 wt % carbon;
from about 0.3 wt % to about 0.5 wt % manganese;
from about 0.15 wt % to about 0.25 wt % silicon;
from about 7.5 wt % to about 8.5 wt % chromium;
from about 0.6 wt % to about 0.8 wt % nickel;
from about 2.0 wt % to about 2.2 wt % molybdenum;
from about 2.2 wt % to about 2.4 wt % tungsten;
from about 3.9 wt % to about 4.1 wt % cobalt;
from about 0.9 wt % to about 1.1 wt % copper;
from about 0.6 wt % to about 0.7 wt % niobium;
from about 0.005 wt % to about 0.015 wt % nitrogen;
from about 0.05 wt % to about 0.15 wt % aluminum;
from about 0.10 wt % to about 0.20 wt % titanium;
from about 0.55 wt % to about 0.65 wt % tantalum;
from about 0.005 wt % to about 0.015 wt % boron; and
iron.
3. The composition according to any preceding clause, comprising:
about 0.17 wt % carbon;
about 0.4 wt % manganese;
about 0.2 wt % silicon;
about 8.0 wt % chromium;
about 0.7 wt % nickel;
about 2.1 wt % molybdenum;
about 2.3 wt % tungsten;
about 4.0 wt % cobalt;
about 1.0 wt % copper;
about 0.65 wt % niobium;
about 0.01 wt % nitrogen;
about 0.1 wt % aluminum;
about 0.15 wt % titanium;
about 0.6 wt % tantalum;
about 0.01 wt % boron; and
iron.
4. The composition according to any preceding clause, wherein the composition comprises balance iron and residual elements.
5. The composition according to any preceding clause, wherein the composition exhibits a stress rupture duration of at least 35 hours when exposed to 62 ksi at 1050° F.
6. The composition according to any preceding clause, wherein the composition exhibits a stress rupture duration of at least 100 hours when exposed to 62 ksi at 1050° F.
7. The composition according to any preceding clause, wherein the composition exhibits a stress rupture duration of at least 350 hours when exposed to 62 ksi at 1050° F.
8. The composition according to any preceding clause, wherein the composition exhibits less than 5% creep deformation for at least 200 hours when exposed to 60 ksi at 1050° F.
9. The composition according to any preceding clause, wherein the composition exhibits less than 5% creep deformation for at least 400 hours when exposed to 60 ksi at 1050° F.
10. The composition according to any preceding clause, wherein the composition exhibits less than 5% creep deformation for at least 800 hours when exposed to 60 ksi at 1050° F.
11. The composition according to any preceding clause, wherein the composition exhibits a hardness loss of less than 4 HRC when exposed to 1050° F. for 1000 hours.
12. The composition according to any preceding clause, wherein the composition exhibits a hardness loss of less than 2 HRC when exposed to 1050° F. for 1000 hours.
13. The composition according to any preceding clause, wherein the composition further comprises a coating.
14. The composition according to any preceding clause, wherein the composition further comprises a coating selected from the group consisting of nickel-cadmium coatings, phosphate-aluminum coatings, and combinations thereof.
15. The composition according to any preceding clause, wherein the composition is a wrought composition, a forged composition, and/or a cast composition.
16. An article comprising a composition, the composition comprising:
from about 0.12 wt % to about 0.23 wt % carbon;
from about 0.2 wt % to about 0.6 wt % manganese;
from about 0.1 wt % to about 0.3 wt % silicon;
from about 7.0 wt % to about 9.0 wt % chromium;
from about 0.5 wt % to about 0.9 wt % nickel;
from about 1.8 wt % to about 2.4 wt % molybdenum;
from about 2.0 wt % to about 2.6 wt % tungsten;
from about 3.5 wt % to about 4.5 wt % cobalt;
from about 0.8 wt % to about 1.2 wt % copper;
from about 0.5 wt % to about 0.8 wt % niobium;
from about 0.005 wt % to about 0.025 wt % nitrogen;
from about 0.05 wt % to about 0.20 wt % aluminum;
from about 0.05 wt % to about 0.25 wt % titanium;
from about 0.4 wt % to about 0.8 wt % tantalum;
from about 0.005 wt % to about 0.025 wt % boron; and
iron.
17. The article according to the preceding clause, wherein the composition is a wrought composition, a forged composition, and/or a cast composition.
18. The article according to any preceding clause, wherein the article is a component of a turbine selected from the group consisting of an inner casing for an in-case steam turbine high pressure rotor, an inner casing for an in-case steam turbine intermediate pressure rotor, an outer casing for an in-case steam turbine high pressure rotor, an outer casing for an in-case steam turbine intermediate pressure rotor, a packing head, a diaphragm casing, and a combination thereof.
19. The article according to any preceding clause, wherein the article is a component of a turbine selected from the group consisting of a nozzle, a shroud, a splash plate, a combustor component, a diffuser case, an inner diffuser case, a compressor case, an inner compressor case, a splitter, an inner barrel, a turbine shell, compressor blades, compressor vanes, guide vanes, retaining rings, and a combination thereof.
20. The article according to any preceding clause, wherein the composition further comprises a coating.

References to “some embodiments” in the above description are not intended to be interpreted as excluding the existence of additional embodiments that also incorporate the recited features.

### Second Alloy Composition.

The embodiments described herein overcome at least some of the disadvantages of known iron-based alloys. The exemplary embodiments described herein include a composition. The composition includes from about 0.20 wt % to about 0.28 wt % carbon, from about 0.3 wt % to about 0.6 wt % manganese, from about 0.05 wt % to about 0.20 wt % silicon, from about 10.0 wt % to about 11.0 wt % chromium, from about 0.3 wt % to about 0.7 wt % nickel, from about 1.35 wt % to about 1.65 wt % molybdenum, from about 1.3 wt % to about 1.6 wt % tungsten, from about 0.85 wt % to about 1.15 wt % cobalt, from about 0.85 wt % to about 1.15 wt % copper, from about 0.25 wt % to about 0.35 wt % niobium, from about 0.05 wt % to about 0.10 wt % nitrogen, from about 0.03 wt % to about 0.07 wt % tantalum, from about 0.20 wt % to about 0.30 wt % vanadium, and iron.

In some embodiments, the composition may include any suitable amount of carbon (C) that facilitates the composition described herein. In some embodiments, the composition includes from about 0.20 wt % to about 0.28 wt % carbon. In some embodiments, the composition includes from about 0.22 wt % to about 0.26 wt % carbon.

In some embodiments, the composition includes at least about 0.20 wt % C, at least about 0.21 wt % C, at least about 0.22 wt % C, at least about 0.23 wt % C, at least about 0.24 wt % C, at least about 0.25 wt % C, at least about 0.26 wt % C, or at least about 0.27 wt % C. In some embodiments, the composition includes at most about 0.21 wt % C, at most about 0.22 wt % C, at most about 0.23 wt % C, at most about 0.24 wt % C, at most about 0.25 wt % C, at most about 0.26 wt % C, at most about 0.27 wt % C, or at most about 0.28 wt % C.

In some embodiments, the composition may include any suitable amount of manganese (Mn) that facilitates the composition described herein. In some embodiments, the composition includes from about 0.3 wt % to about 0.6 wt % manganese. In some embodiments, the composition includes from about 0.4 wt % to about 0.5 wt % manganese.

In some embodiments, the composition includes at least about 0.30 wt % Mn, at least about 0.35 wt % Mn, at least about 0.40 wt % Mn, at least about 0.45 wt % Mn, at least about 0.50 wt % Mn, or at least about 0.55 wt % Mn. In some embodiments, the composition includes at most about 0.35 wt % Mn, at most about 0.40 wt % Mn, at most about 0.45 wt % Mn, at most about 0.50 wt % Mn, at most about 0.55 wt % Mn, or at most about 0.60 wt % Mn.

In some embodiments, the composition may include any suitable amount of silicon (Si) that facilitates the composition described herein. In some embodiments, the composition includes from about 0.05 wt % to about 0.20 wt % silicon. In some embodiments, the composition includes from about 0.05 wt % to about 0.10 wt % silicon.

In some embodiments, the composition includes at least about 0.05 wt % Si, at least about 0.10 wt % Si, or at least about 0.15 wt % Si. In some embodiments, the composition includes at most about 0.10 wt % Si, at most about 0.15 wt % Si, or at most about 0.20 wt % Si.

In some embodiments, the composition may include any suitable amount of chromium (Cr) that facilitates the composition described herein. In some embodiments, the composition includes Cr. In some embodiments, the composition includes from about 10.0 wt % to about 11.0 wt % chromium. In some embodiments, the composition includes from about 10.0 wt % to about 10.6 wt % chromium.

In some embodiments, the composition includes at least about 10.0 wt % Cr, at least about 10.1 wt % Cr, at least about 10.2 wt % Cr, at least about 10.3 wt % Cr, at least about 10.4 wt % Cr, at least about 10.5 wt % Cr, at least about 10.6 wt % Cr, at least about 10.7 wt % Cr, at least about 10.8 wt % Cr, or at least about 10.9 wt % Cr. In some embodiments, the composition includes at most about 10.1 wt % Cr, at most about 10.2 wt % Cr, at most about 10.3 wt % Cr, at most about 10.4 wt % Cr, at most about 10.5 wt % Cr, at most about 10.6 wt % Cr, at most about 10.7 wt % Cr, at most about 10.8 wt % Cr, at most about 10.9 wt % Cr, or at most about 11.0 wt % Cr.

In some embodiments, the composition may include any suitable amount of nickel (Ni) that facilitates the composition described herein. In some embodiments, the composition includes from about 0.3 wt % to about 0.7 wt % nickel. In some embodiments, the composition includes from about 0.4 wt % to about 0.6 wt % nickel.

In some embodiments, the composition includes at least about 0.30 wt % Ni, at least about 0.35 wt % Ni, at least about 0.40 wt % Ni, at least about 0.45 wt % Ni, at least about 0.50 wt % Ni, at least about 0.55 wt % Ni, at least about 0.60 wt % Ni, or at least about 0.65 wt % Ni. In some embodiments, the composition includes at most about 0.35 wt % Ni, at most about 0.40 wt % Ni, at most about 0.45 wt % Ni, at most about 0.50 wt % Ni, at most about 0.55 wt % Ni, at most about 0.60 wt % Ni, at most about 0.65 wt % Ni, or at most about 0.70 wt % Ni.

In some embodiments, the composition may include any suitable amount of molybdenum (Mo) that facilitates the composition described herein. In some embodiments, the composition includes from about 1.35 wt % to about 1.65 wt % molybdenum. In some embodiments, the composition includes from about 1.45 wt % to about 1.55 wt % molybdenum.

In some embodiments, the composition includes at least about 1.35 wt % Mo, at least about 1.40 wt % Mo, at least about 1.45 wt % Mo, at least about 1.50 wt % Mo, or at least about 1.55 wt % Mo, or at least about 1.60 wt % Mo. In some embodiments, the composition includes at most about 1.40 wt % Mo, at most about 1.45 wt % Mo, at most about 1.50 wt % Mo, at most about 1.55 wt % Mo, at most about 1.60 wt % Mo, or at most about 1.65 wt % Mo.

In some embodiments, the composition may include any suitable amount of tungsten (W) that facilitates the composition described herein. In some embodiments, the composition includes from about 1.3 wt % to about 1.6 wt % tungsten. In some embodiments, the composition includes from about 1.4 wt % to about 1.5 wt % tungsten.

In some embodiments, the composition includes at least about 1.3 wt % W, at least about 1.35 wt % W, at least about 1.4 wt % W, at least about 1.45 wt % W, at least about 1.5 wt % W, or at least about 1.55 wt % W. In some embodiments, the composition includes at most about 1.35 wt % W, at most about 1.4 wt % W, at most about 1.45 wt % W, at most about 1.5 wt % W, at most about 1.55 wt % W, or at most about 1.60 wt % W.

In some embodiments, the composition may include any suitable amount of cobalt (Co) that facilitates the composition described herein. In some embodiments, the composition includes from about 0.85 wt % to about 1.15 wt % cobalt. In some embodiments, the composition includes from about 0.95 wt % to about 1.05 wt % cobalt.

In some embodiments, the composition includes at least about 0.85 wt % Co, at least about 0.90 wt % Co, at least about 0.95 wt % Co, at least about 1.0 wt % Co, at least about 1.05 wt % Co, or at least about 1.1 wt % Co. In some embodiments, the composition includes at most about 0.90 wt % Co, at most about 0.95 wt % Co, at most about 1.0 wt % Co, at most about 1.05 wt % Co, at most about 1.1 wt % Co, or at most about 1.15 wt % Co.

In some embodiments, the composition may include any suitable amount of copper (Cu) that facilitates the composition described herein. In some embodiments, the composition includes from about 0.85 wt % to about 1.15 wt % copper. In some embodiments, the composition includes from about 0.95 wt % to about 1.05 wt % copper.

In some embodiments, the composition includes at least about 0.85 wt % Cu, at least about 0.90 wt % Cu, at least about 0.95 wt % Cu, at least about 1.0 wt % Cu, at least about 1.05 wt % Cu, or at least about 1.1 wt % Cu. In some embodiments, the composition includes at most about 0.90 wt % Cu, at most about 0.95 wt % Cu, at most about 1.0 wt % Cu, at most about 1.05 wt % Cu, at most about 1.1 wt % Cu, or at most about 1.15 wt % Cu.

In some embodiments, the composition may include any suitable amount of niobium (Nb) that facilitates the composition described herein. In some embodiments, the composition includes from about 0.25 wt % to about 0.35 wt % niobium. In some embodiments, the composition includes from about 0.26 wt % to about 0.30 wt % niobium.

In some embodiments, the composition includes at least about 0.25 wt % Nb, at least about 0.26 wt % Nb, at least about 0.27 wt % Nb, at least about 0.28 wt % Nb, at least about 0.29 wt % Nb, at least about 0.30 wt % Nb, at least about 0.31 wt % Nb, at least about 0.32 wt % Nb, at least about 0.33 wt % Nb, or at least about 0.34 wt % Nb. In some embodiments, the composition includes at most about 0.26 wt % Nb, at most about 0.27 wt % Nb, at most about 0.28 wt % Nb, at most about 0.29 wt % Nb, at most about 0.30 wt % Nb, at most about 0.31 wt % Nb, at most about 0.32 wt % Nb, at most about 0.33 wt % Nb, at most about 0.34 wt % Nb, or at most about 0.35 wt % Nb.

In some embodiments, the composition may include any suitable amount of nitrogen (N) that facilitates the composition described herein. In some embodiments, the composition includes from about 0.05 wt % to about 0.10 wt % nitrogen. In some embodiments, the composition includes from about 0.05 wt % to about 0.08 wt % nitrogen.

In some embodiments, the composition includes at least about 0.05 wt % N, at least about 0.06 wt % N, at least about 0.07 wt % N, at least about 0.08 wt % N, or at least about 0.09 wt % N. In some embodiments, the composition includes at most about 0.06 wt % N, at most about 0.07 wt % N, at most about 0.08 wt % N, at most about 0.09 wt % N, or at most about 0.10 wt % N.

In some embodiments, the composition may include any suitable amount of tantalum (Ta) that facilitates the composition described herein. In some embodiments, the composition includes from about 0.03 wt % to about 0.07 wt % tantalum. In some embodiments, the composition includes from about 0.04 wt % to about 0.06 wt % tantalum.

In some embodiments, the composition includes at least about 0.03 wt % Ta, at least about 0.04 wt % Ta, at least about 0.05 wt % Ta, or at least about 0.06 wt % Ta. In some embodiments, the composition includes at most about 0.04 wt % Ta, at most about 0.05 wt % Ta, or at most about 0.06 wt % Ta, or at most about 0.07 wt % Ta.

In some embodiments, the composition may include any suitable amount of vanadium (V) that facilitates the composition described herein. In some embodiments, the composition includes from about 0.20 wt % to about 0.30 wt % vanadium. In some embodiments, the composition includes from about 0.23 wt % to about 0.27 wt % vanadium.

In some embodiments, the composition includes at least about 0.20 wt % V, at least about 0.21 wt % V, at least about 0.22 wt % V, at least about 0.23 wt % V, at least about 0.24 wt % V, at least about 0.25 wt % V, at least about 0.26 wt % V, at least about 0.27 wt % V, at least about 0.28 wt % V, or at least about 0.29 wt % V. In some embodiments, the composition includes at most about 0.21 wt % V, at most about 0.22 wt % V, at most about 0.23 wt % V, at most about 0.24 wt % V, at most about 0.25 wt % V, at most about 0.26 wt % V, at most about 0.27 wt % V, at most about 0.28 wt % V, at most about 0.29 wt % V, or at most about 0.30 wt % V.

In some embodiments, the composition may include any suitable amount of iron (Fe) that facilitates the composition described herein. In many embodiments, the composition includes balance iron. In these embodiments, the amount of iron is sufficient to bring the total weight percent of the composition to 100 wt %.

In some embodiments, the composition includes at least about 80 wt % Fe, at least about 81 wt % Fe, at least about 82 wt % Fe, at least about 83 wt % Fe, at least about 84 wt % Fe, or at least about 85 wt % Fe. In some embodiments, the composition includes at most about 80 wt % Fe, at most about 81 wt % Fe, at most about 82 wt % Fe, at most about 83 wt % Fe, at most about 84 wt % Fe, or at most about 85 wt % Fe.

In some embodiments, the composition may include tramp elements. As used herein, tramp elements include elements that may be inherently present in the composition and substantially alter the material properties of the composition. In some embodiments, tramp elements are not necessary in the composition and provide no benefit to the composition.

In some embodiments, the composition includes balance iron and residual elements. As used herein, residual elements include elements that may be inherently present in the composition but do not substantially alter the material properties of the composition if appropriately limited.

In these embodiments, the amount of iron and residual elements is sufficient to bring the total weight percent of the composition to 100 wt %.

In some embodiments, the composition further comprises a coating. In some embodiments, the composition further comprises a coating selected from the group consisting of nickel-cadmium coatings, phosphate-aluminum coatings, and combinations thereof.

In some embodiments, the composition exhibits a stress rupture duration of at least 35 hours when exposed to 62 ksi at 1050° F. In some embodiments, the composition exhibits a stress rupture duration of at least 100 hours when exposed to 62 ksi at 1050° F. In some embodiments, the composition exhibits a stress rupture duration of at least 300 hours when exposed to 62 ksi at 1050° F.

In some embodiments, the composition exhibits less than 5% creep deformation for at least 100 hours when exposed to 60 ksi at 1050° F. In some embodiments, the composition exhibits less than 5% creep deformation for at least 200 hours when exposed to 60 ksi at 1050° F. In some embodiments, the composition exhibits less than 5% creep deformation for at least 400 hours when exposed to 60 ksi at 1050° F.

In some embodiments, the composition exhibits a hardness loss of less than 6 HRC when exposed to 1050° F. for 1000 hours. In some embodiments, the composition exhibits a hardness loss of less than 5 HRC when exposed to 1050° F. for 1000 hours.

In some embodiments, the composition exhibits at least 15 Ft-lbs Charpy energy absorbed at room temperature. In some embodiments, wherein the composition exhibits at least 25 Ft-lbs Charpy energy absorbed at room temperature.

In some embodiments, the composition is an alloy composition. In some embodiments, the composition is a wrought composition, a forged composition, and/or a cast composition.

Also described herein is an article including the composition. Generally, the composition may be included in any suitable article known in the art that facilitates the use of the composition described herein.

In some embodiments, the article is produced using, but not limited to only using, a wrought process, a forge process, and/or a cast process. In some embodiments, the article is produced using a cast process.

In some embodiments, the article is a component of a turbine. In some embodiments, the turbine is a gas turbine or a steam turbine.

In some embodiments, the article is a component of a turbine such as, but not limited to only being, a nozzle, a shroud, a splash plate, a combustor component, a diffuser case, an inner diffuser case, a compressor case, an inner compressor case, a splitter, an inner barrel, a turbine shell, compressor blades, compressor vanes, guide vanes, retaining rings, and a combination thereof.

In some embodiments, the article is a component of a turbine such as, but not limited to only being, an inner casing for an in-case steam turbine high pressure rotor, an inner casing for an in-case steam turbine intermediate pressure rotor, an outer casing for an in-case steam turbine high pressure rotor, an outer casing for an in-case steam turbine intermediate pressure rotor, a packing head, a diaphragm casing, and a combination thereof.

In some embodiments, the article is a component of a turbo charger component. In some embodiments, the article is a component of an automobile.

Further aspects of the present disclosure are provided by the subject matter of the following clauses:
1. A composition comprising:
from about 0.20 wt % to about 0.28 wt % carbon;
from about 0.3 wt % to about 0.6 wt % manganese;
from about 0.05 wt % to about 0.20 wt % silicon;
from about 10.0 wt % to about 11.0 wt % chromium;
from about 0.3 wt % to about 0.7 wt % nickel;
from about 1.35 wt % to about 1.65 wt % molybdenum;
from about 1.3 wt % to about 1.6 wt % tungsten;
from about 0.85 wt % to about 1.15 wt % cobalt;
from about 0.85 wt % to about 1.15 wt % copper;
from about 0.25 wt % to about 0.35 wt % niobium;
from about 0.05 wt % to about 0.10 wt % nitrogen;
from about 0.03 wt % to about 0.07 wt % tantalum;
from about 0.20 wt % to about 0.30 wt % vanadium; and
iron.
2. The composition according to the preceding clause, comprising:
from about 0.22 wt % to about 0.26 wt % carbon;
from about 0.4 wt % to about 0.5 wt % manganese;
from about 0.05 wt % to about 0.10 wt % silicon;
from about 10.0 wt % to about 10.6 wt % chromium;
from about 0.4 wt % to about 0.6 wt % nickel;
from about 1.45 wt % to about 1.55 wt % molybdenum;
from about 1.4 wt % to about 1.5 wt % tungsten;
from about 0.95 wt % to about 1.05 wt % cobalt;
from about 0.95 wt % to about 1.05 wt % copper;
from about 0.26 wt % to about 0.30 wt % niobium;
from about 0.05 wt % to about 0.08 wt % nitrogen;
from about 0.04 wt % to about 0.06 wt % tantalum;
from about 0.23 wt % to about 0.27 wt % vanadium; and
iron.
3. The composition according to any preceding clause, comprising:
about 0.24 wt % carbon;
about 0.5 wt % manganese;
about 0.075 wt % silicon;
about 10.3 wt % chromium;
about 0.5 wt % nickel;
about 1.5 wt % molybdenum;
about 1.45 wt % tungsten;
about 1.0 wt % cobalt;
about 1.0 wt % copper;
about 0.28 wt % niobium;
about 0.065 wt % nitrogen;
about 0.05 wt % tantalum;
about 0.25 wt % vanadium; and
iron.
4. The composition according to any preceding clause, wherein the composition comprises balance iron and residual elements.
5. The composition according to any preceding clause, wherein the composition exhibits a stress rupture duration of at least 35 hours when exposed to 62 ksi at 1050° F.
6. The composition according to any preceding clause, wherein the composition exhibits a stress rupture duration of at least 100 hours when exposed to 62 ksi at 1050° F.
7. The composition according to any preceding clause, wherein the composition exhibits a stress rupture duration of at least 300 hours when exposed to 62 ksi at 1050° F.
8. The composition according to any preceding clause, wherein the composition exhibits less than 5% creep deformation for at least 100 hours when exposed to 60 ksi at 1050° F.
9. The composition according to any preceding clause, wherein the composition exhibits less than 5% creep deformation for at least 200 hours when exposed to 60 ksi at 1050° F.
10. The composition according to any preceding clause, wherein the composition exhibits less than 5% creep deformation for at least 400 hours when exposed to 60 ksi at 1050° F.
11. The composition according to any preceding clause, wherein the composition exhibits a hardness loss of less than 6 HRC when exposed to 1050° F. for 1000 hours.
12. The composition according to any preceding clause, wherein the composition exhibits a hardness loss of less than 5 HRC when exposed to 1050° F. for 1000 hours.
13. The composition according to any preceding clause, wherein the composition exhibits at least 15 Ft-lbs Charpy energy absorbed at room temperature.
14. The composition according to any preceding clause, wherein the composition exhibits at least 25 Ft-lbs Charpy energy absorbed at room temperature.
15. The composition according to any preceding clause, wherein the composition is a wrought composition, a forged composition, and/or a cast composition.
16. An article comprising a composition, the composition comprising:
from about 0.20 wt % to about 0.28 wt % carbon;
from about 0.3 wt % to about 0.6 wt % manganese;
from about 0.05 wt % to about 0.20 wt % silicon;
from about 10.0 wt % to about 11.0 wt % chromium;
from about 0.3 wt % to about 0.7 wt % nickel;
from about 1.35 wt % to about 1.65 wt % molybdenum;
from about 1.3 wt % to about 1.6 wt % tungsten;
from about 0.85 wt % to about 1.15 wt % cobalt;
from about 0.85 wt % to about 1.15 wt % copper;
from about 0.25 wt % to about 0.35 wt % niobium;
from about 0.05 wt % to about 0.10 wt % nitrogen;
from about 0.03 wt % to about 0.07 wt % tantalum;
from about 0.20 wt % to about 0.30 wt % vanadium; and
iron.
17. The article according to the preceding clause, wherein the composition is a wrought composition, a forged composition, and/or a cast composition.
18. The article according to any preceding clause, wherein the article is a component of a turbine selected from the group consisting of an inner casing for an in-case steam turbine high pressure rotor, an inner casing for an in-case steam turbine intermediate pressure rotor, an outer casing for an in-case steam turbine high pressure rotor, an outer casing for an in-case steam turbine intermediate pressure rotor, a packing head, a diaphragm casing, and a combination thereof.
19. The article according to any preceding clause, wherein the article is a component of a turbine selected from the group consisting of a nozzle, a shroud, a splash plate, a combustor component, a diffuser case, an inner diffuser case, a compressor case, an inner compressor case, a splitter, an inner barrel, a turbine shell, compressor blades, compressor vanes, guide vanes, retaining rings, and a combination thereof.
20. The article according to any preceding clause, wherein the composition exhibits at least 15 Ft-lbs Charpy energy absorbed at room temperature.

References to “some embodiments” in the above description are not intended to be interpreted as excluding the existence of additional embodiments that also incorporate the recited features.

### Third Alloy Composition.

The embodiments described herein overcome at least some of the disadvantages of known iron-based alloys. The exemplary embodiments described herein include a composition. The composition includes from about 0.16 wt % to about 0.24 wt % carbon, from about 0.4 wt % to about 0.8 wt % manganese, from about 0.10 wt % to about 0.30 wt % silicon, from about 9.5 wt % to about 11.0 wt % chromium, from about 0.3 wt % to about 0.7 wt % nickel, from about 2.0 wt % to about 2.8 wt % molybdenum, from about 1.2 wt % to about 2.0 wt % tungsten, from about 3.7 wt % to about 4.3 wt % cobalt, from about 1.1 wt % to about 1.5 wt % copper, from about 0.35 wt % to about 0.55 wt % niobium, from about 0.005 wt % to about 0.025 wt % nitrogen, from about 0.20 wt % to about 0.40 wt % tantalum, from about 0.01 wt % to about 0.05 wt % aluminum, from about 0.005 wt % to about 0.025 wt % boron, and iron.

In some embodiments, the composition may include any suitable amount of carbon (C) that facilitates the composition described herein. In some embodiments, the composition includes from about 0.16 wt % to about 0.24 wt % carbon. In some embodiments, the composition includes from about 0.18 wt % to about 0.22 wt % carbon.

In some embodiments, the composition includes at least about 0.16 wt % C, at least about 0.17 wt % C, at least about 0.18 wt % C, at least about 0.19 wt % C, at least about 0.20 wt % C, at least about 0.21 wt % C, at least about 0.22 wt % C, or at least about 0.23 wt % C. In some embodiments, the composition includes at most about 0.17 wt % C, at most about 0.18 wt % C, at most about 0.19 wt % C, at most about 0.20 wt % C, at most about 0.21 wt % C, at most about 0.22 wt % C, at most about 0.23 wt % C, or at most about 0.24 wt % C.

In some embodiments, the composition may include any suitable amount of manganese (Mn) that facilitates the composition described herein. In some embodiments, the composition includes from about 0.4 wt % to about 0.8 wt % manganese. In some embodiments, the composition includes from about 0.5 wt % to about 0.7 wt % manganese.

In some embodiments, the composition includes at least about 0.40 wt % Mn, at least about 0.45 wt % Mn, at least about 0.50 wt % Mn, at least about 0.55 wt % Mn, at least about 0.60 wt % Mn, at least about 0.65 wt % Mn, at least about 0.70 wt % Mn, or at least about 0.75 wt % Mn. In some embodiments, the composition includes at most about 0.45 wt % Mn, at most about 0.50 wt % Mn, at most about 0.55 wt % Mn, at most about 0.60 wt % Mn, at most about 0.65 wt % Mn, at most about 0.70 wt % Mn, at most about 0.75 wt % Mn, or at most about 0.80 wt % Mn.

In some embodiments, the composition may include any suitable amount of silicon (Si) that facilitates the composition described herein. In some embodiments, the composition includes from about 0.10 wt % to about 0.30 wt % silicon. In some embodiments, the composition includes from about 0.15 wt % to about 0.25 wt % silicon.

In some embodiments, the composition includes at least about 0.10 wt % Si, at least about 0.15 wt % Si, at least about 0.20 wt % Si, or at least about 0.25 wt % Si. In some embodiments, the composition includes at most about 0.15 wt % Si, at most about 0.20 wt % Si, at most about 0.25 wt % Si, or at most about 0.30 wt % Si.

In some embodiments, the composition may include any suitable amount of chromium (Cr) that facilitates the composition described herein. In some embodiments, the composition includes Cr. In some embodiments, the composition includes from about 9.5 wt % to about 11.0 wt % chromium. In some embodiments, the composition includes from about 10.0 wt % to about 10.6 wt % chromium.

In some embodiments, the composition includes at least about 9.5 wt % Cr, at least about 9.6 wt % Cr, at least about 9.7 wt % Cr, at least about 9.8 wt % Cr, at least about 9.9 wt % Cr, at least about 10.0 wt % Cr, at least about 10.1 wt % Cr, at least about 10.2 wt % Cr, at least about 10.3 wt % Cr, at least about 10.4 wt % Cr, at least about 10.5 wt % Cr, at least about 10.6 wt % Cr, at least about 10.7 wt % Cr, at least about 10.8 wt % Cr, or at least about 10.9 wt % Cr.

In some embodiments, the composition includes at most about 9.6 wt % Cr, at most about 9.7 wt % Cr, at most about 9.8 wt % Cr, at most about 9.9 wt % Cr, at most about 10.0 wt % Cr, at most about 10.1 wt % Cr, at most about 10.2 wt % Cr, at most about 10.3 wt % Cr, at most about 10.4 wt % Cr, at most about 10.5 wt % Cr, at most about 10.6 wt % Cr, at most about 10.7 wt % Cr, at most about 10.8 wt % Cr, at most about 10.9 wt % Cr, or at most about 11.0 wt % Cr.

In some embodiments, the composition may include any suitable amount of nickel (Ni) that facilitates the composition described herein. In some embodiments, the composition includes from about 0.3 wt % to about 0.7 wt % nickel. In some embodiments, the composition includes from about 0.4 wt % to about 0.6 wt % nickel.

In some embodiments, the composition includes at least about 0.30 wt % Ni, at least about 0.35 wt % Ni, at least about 0.40 wt % Ni, at least about 0.45 wt % Ni, at least about 0.50 wt % Ni, at least about 0.55 wt % Ni, at least about 0.60 wt % Ni, or at least about 0.65 wt % Ni. In some embodiments, the composition includes at most about 0.35 wt % Ni, at most about 0.40 wt % Ni, at most about 0.45 wt % Ni, at most about 0.50 wt % Ni, at most about 0.55 wt % Ni, at most about 0.60 wt % Ni, at most about 0.65 wt % Ni, or at most about 0.70 wt % Ni.

In some embodiments, the composition may include any suitable amount of molybdenum (Mo) that facilitates the composition described herein. In some embodiments, the composition includes from about 2.0 wt % to about 2.8 wt % molybdenum. In some embodiments, the composition includes from about 2.2 wt % to about 2.6 wt % molybdenum.

In some embodiments, the composition includes at least about 2.0 wt % Mo, at least about 2.1 wt % Mo, at least about 2.2 wt % Mo, at least about 2.3 wt % Mo, at least about 2.4 wt % Mo, at least about 2.5 wt % Mo, at least about 2.6 wt % Mo, or at least about 2.7 wt % Mo. In some embodiments, the composition includes at most about 2.1 wt % Mo, at most about 2.2 wt % Mo, at most about 2.3 wt % Mo, at most about 2.4 wt % Mo, at most about 2.5 wt % Mo, at most about 2.6 wt % Mo, at most about 2.7 wt % Mo, or at most about 2.8 wt % Mo.

In some embodiments, the composition may include any suitable amount of tungsten (W) that facilitates the composition described herein. In some embodiments, the composition includes from about 1.2 wt % to about 2.0 wt % tungsten. In some embodiments, the composition includes from about 1.4 wt % to about 1.8 wt % tungsten.

In some embodiments, the composition includes at least about 1.2 wt % W, at least about 1.25 wt % W, at least about 1.3 wt % W, at least about 1.35 wt % W, at least about 1.4 wt % W, at least about 1.45 wt % W, at least about 1.5 wt % W, at least about 1.55 wt % W, at least about 1.6 wt % W, at least about 1.65 wt % W, at least about 1.7 wt % W, at least about 1.75 wt % W, at least about 1.8 wt % W, at least about 1.85 wt % W, at least about 1.9 wt % W, or at least about 1.95 wt % W. In some embodiments, the composition includes at most about 1.25 wt % W, at most about 1.3 wt % W, at most about 1.35 wt % W, at most about 1.4 wt % W, at most about 1.45 wt % W, at most about 1.5 wt % W, at most about 1.55 wt % W, at most about 1.6 wt % W, at most about 1.65 wt % W, at most about 1.7 wt % W, at most about 1.75 wt % W, at most about 1.8 wt % W, at most about 1.85 wt % W, at most about 1.9 wt % W, at most about 1.95 wt % W, or at most about 2.0 wt % W.

In some embodiments, the composition may include any suitable amount of cobalt (Co) that facilitates the composition described herein. In some embodiments, the composition includes from about 3.7 wt % to about 4.3 wt % cobalt. In some embodiments, the composition includes from about 3.8 wt % to about 4.2 wt % cobalt.

In some embodiments, the composition includes at least about 3.7 wt % Co, at least about 3.8 wt % Co, at least about 3.9 wt % Co, at least about 4.0 wt % Co, at least about 4.1 wt % Co, or at least about 4.2 wt % Co. In some embodiments, the composition includes at most about 3.8 wt % Co, at most about 3.9 wt % Co, at most about 4.0 wt % Co, at most about 4.1 wt % Co, at most about 4.2 wt % Co, or at most about 4.3 wt % Co.

In some embodiments, the composition may include any suitable amount of copper (Cu) that facilitates the composition described herein. In some embodiments, the composition includes from about 1.1 wt % to about 1.5 wt % copper. In some embodiments, the composition includes from about 1.2 wt % to about 1.4 wt % copper.

In some embodiments, the composition includes at least about 1.1 wt % Cu, at least about 1.2 wt % Cu, at least about 1.3 wt % Cu, or at least about 1.4 wt % Cu. In some embodiments, the composition includes at most about 1.2 wt % Cu, at most about 1.3 wt % Cu, at most about 1.4 wt % Cu, or at most about 1.5 wt % Cu.

In some embodiments, the composition may include any suitable amount of niobium (Nb) that facilitates the composition described herein. In some embodiments, the composition includes from about 0.35 wt % to about 0.55 wt % niobium. In some embodiments, the composition includes from about 0.40 wt % to about 0.50 wt % niobium.

In some embodiments, the composition includes at least about 0.35 wt % Nb, at least about 0.36 wt % Nb, at least about 0.37 wt % Nb, at least about 0.38 wt % Nb, at least about 0.39 wt % Nb, at least about 0.40 wt % Nb, at least about 0.41 wt % Nb, at least about 0.42 wt % Nb, at least about 0.43 wt % Nb, at least about 0.44 wt % Nb, at least about 0.45 wt % Nb, at least about 0.46 wt % Nb, at least about 0.47 wt % Nb, at least about 0.48 wt % Nb, at least about 0.49 wt % Nb, at least about 0.50 wt % Nb, at least about 0.51 wt % Nb, at least about 0.52 wt % Nb, at least about 0.53 wt % Nb, or at least about 0.54 wt % Nb. In some embodiments, the composition includes at most about 0.36 wt % Nb, at most about 0.37 wt % Nb, at most about 0.38 wt % Nb, at most about 0.39 wt % Nb, at most about 0.40 wt % Nb, at most about 0.41 wt % Nb, at most about 0.42 wt % Nb, at most about 0.43 wt % Nb, at most about 0.44 wt % Nb, at most about 0.45 wt % Nb, at most about 0.46 wt % Nb, at most about 0.47 wt % Nb, at most about 0.48 wt % Nb, at most about 0.49 wt % Nb, at most about 0.50 wt % Nb, at most about 0.51 wt % Nb, at most about 0.52 wt % Nb, at most about 0.53 wt % Nb, at most about 0.54 wt % Nb, or at most about 0.55 wt % Nb.

In some embodiments, the composition may include any suitable amount of nitrogen (N) that facilitates the composition described herein. In some embodiments, the composition includes from about 0.005 wt % to about 0.025 wt % nitrogen. In some embodiments, the composition includes from about 0.005 wt % to about 0.015 wt % nitrogen.

In some embodiments, the composition includes at least about 0.005 wt % N, at least about 0.01 wt % N, at least about 0.015 wt % N, or at least about 0.02 wt % N. In some embodiments, the composition includes at most about 0.01 wt % N, at most about 0.015 wt % N, at most about 0.02 wt % N, or at most about 0.025 wt % N.

In some embodiments, the composition may include any suitable amount of tantalum (Ta) that facilitates the composition described herein. In some embodiments, the composition includes from about 0.20 wt % to about 0.40 wt % tantalum. In some embodiments, the composition includes from about 0.25 wt % to about 0.35 wt % tantalum.

In some embodiments, the composition includes at least about 0.20 wt % Ta, at least about 0.25 wt % Ta, at least about 0.30 wt % Ta, or at least about 0.35 wt % Ta. In some embodiments, the composition includes at most about 0.25 wt % Ta, at most about 0.30 wt % Ta, at most about 0.35 wt % Ta, or at most about 0.40 wt % Ta.

In some embodiments, the composition may include any suitable amount of aluminum (Al) that facilitates the composition described herein. In some embodiments, the composition includes from about 0.01 wt % to about 0.05 wt % aluminum. In some embodiments, the composition includes from about 0.02 wt % to about 0.04 wt % aluminum.

In some embodiments, the composition includes at least about 0.010 wt % Al, at least about 0.015 wt % Al, at least about 0.020 wt % Al, at least about 0.025 wt % Al, at least about 0.030 wt % Al, at least about 0.035 wt % Al, at least about 0.040 wt % Al, or at least about 0.045 wt % Al. In some embodiments, the composition includes at most about 0.015 wt % Al, at most about 0.020 wt % Al, at most about 0.025 wt % Al, at most about 0.030 wt % Al, at most about 0.035 wt % Al, at most about 0.040 wt % Al, at most about 0.045 wt % Al, or at most about 0.050 wt % Al.

In some embodiments, the composition may include any suitable amount of boron (B) that facilitates the composition described herein. In some embodiments, the composition includes from about 0.005 wt % to about 0.025 wt % boron. In some embodiments, the composition includes from about 0.005 wt % to about 0.015 wt % boron.

In some embodiments, the composition includes at least about 0.005 wt % B, at least about 0.010 wt % B, at least about 0.015 wt % B, or at least about 0.020 wt % B. In some embodiments, the composition includes at most about 0.010 wt % B, at most about 0.015 wt % B, at most about 0.020 wt % B, or at most about 0.025 wt % B.

In some embodiments, the composition may include any suitable amount of iron (Fe) that facilitates the composition described herein. In many embodiments, the composition includes balance iron. In these embodiments, the amount of iron is sufficient to bring the total weight percent of the composition to 100 wt %.

In some embodiments, the composition includes at least about 75 wt % Fe, at least about 76 wt % Fe, at least about 77 wt % Fe, at least about 78 wt % Fe, at least about 79 wt % Fe, at least about 80 wt % Fe, or at least about 81 wt % Fe. In some embodiments, the composition includes at most about 76 wt % Fe, at most about 77 wt % Fe, at most about 78 wt % Fe, at most about 79 wt % Fe, at most about 80 wt % Fe, at most about 81 wt % Fe, or at most about 82 wt % Fe.

In some embodiments, the composition may include tramp elements. As used herein, tramp elements include elements that may be inherently present in the composition and substantially alter the material properties of the composition. In some embodiments, tramp elements are not necessary in the composition and provide no benefit to the composition.

In some embodiments, the composition includes balance iron and residual elements. As used herein, residual elements include elements that may be inherently present in the composition but do not substantially alter the material properties of the composition if appropriately limited.

In these embodiments, the amount of iron and residual elements is sufficient to bring the total weight percent of the composition to 100 wt %.

In some embodiments, the composition further comprises a coating. In some embodiments, the composition further comprises a coating selected from the group consisting of nickel-cadmium coatings, phosphate-aluminum coatings, and combinations thereof.

In some embodiments, the composition exhibits a stress rupture duration of at least 25 hours when exposed to 62 ksi at 1050° F. In some embodiments, the composition exhibits a stress rupture duration of at least 35 hours when exposed to 62 ksi at 1050° F. In some embodiments, the composition exhibits a stress rupture duration of at least 40 hours when exposed to 62 ksi at 1050° F.

In some embodiments, the composition exhibits at least 8 Ft-lbs Charpy energy absorbed at room temperature. In some embodiments, wherein the composition exhibits at least 12 Ft-lbs Charpy energy absorbed at room temperature.

In some embodiments, the composition is an alloy composition. In some embodiments, the composition is a wrought composition, a forged composition, and/or a cast composition.

Also described herein is an article including the composition. Generally, the composition may be included in any suitable article known in the art that facilitates the use of the composition described herein.

In some embodiments, the article is produced using, but not limited to only using, a wrought process, a forge process, and/or a cast process. In some embodiments, the article is produced using a cast process.

In some embodiments, the article is a component of a turbine. In some embodiments, the turbine is a gas turbine or a steam turbine.

In some embodiments, the article is a component of a turbine such as, but not limited to only being, a nozzle, a shroud, a splash plate, a combustor component, a diffuser case, an inner diffuser case, a compressor case, an inner compressor case, a splitter, an inner barrel, a turbine shell, compressor blades, compressor vanes, guide vanes, retaining rings, and a combination thereof.

In some embodiments, the article is a component of a turbine such as, but not limited to only being, an inner casing for an in-case steam turbine high pressure rotor, an inner casing for an in-case steam turbine intermediate pressure rotor, an outer casing for an in-case steam turbine high pressure rotor, an outer casing for an in-case steam turbine intermediate pressure rotor, a packing head, a diaphragm casing, and a combination thereof.

In some embodiments, the article is a component of a turbo charger component. In some embodiments, the article is a component of an automobile.

Further aspects of the present disclosure are provided by the subject matter of the following clauses:
1. A composition comprising:
from about 0.16 wt % to about 0.24 wt % carbon;
from about 0.4 wt % to about 0.8 wt % manganese;
from about 0.10 wt % to about 0.30 wt % silicon;
from about 9.5 wt % to about 11.0 wt % chromium;
from about 0.3 wt % to about 0.7 wt % nickel;
from about 2.0 wt % to about 2.8 wt % molybdenum;
from about 1.2 wt % to about 2.0 wt % tungsten;
from about 3.7 wt % to about 4.3 wt % cobalt;
from about 1.1 wt % to about 1.5 wt % copper;
from about 0.35 wt % to about 0.55 wt % niobium;
from about 0.005 wt % to about 0.025 wt % nitrogen;
from about 0.20 wt % to about 0.40 wt % tantalum;
from about 0.01 wt % to about 0.05 wt % aluminum;
from about 0.005 wt % to about 0.025 wt % boron; and
iron.
2. The composition according to the preceding clause, comprising:
from about 0.18 wt % to about 0.22 wt % carbon;
from about 0.5 wt % to about 0.7 wt % manganese;
from about 0.15 wt % to about 0.25 wt % silicon;
from about 10.0 wt % to about 10.6 wt % chromium;
from about 0.4 wt % to about 0.6 wt % nickel;
from about 2.2 wt % to about 2.6 wt % molybdenum;
from about 1.4 wt % to about 1.8 wt % tungsten;
from about 3.8 wt % to about 4.2 wt % cobalt;
from about 1.2 wt % to about 1.4 wt % copper;
from about 0.40 wt % to about 0.50 wt % niobium;
from about 0.005 wt % to about 0.125 wt % nitrogen;
from about 0.25 wt % to about 0.35 wt % tantalum;
from about 0.02 wt % to about 0.04 wt % aluminum;
from about 0.005 wt % to about 0.015 wt % boron; and
iron.
3. The composition according to any preceding clause, comprising:
about 0.2 wt % carbon;
about 0.6 wt % manganese;
about 0.2 wt % silicon;
about 10.3 wt % chromium;
about 0.5 wt % nickel;
about 2.4 wt % molybdenum;
about 1.6 wt % tungsten;
about 4.0 wt % cobalt;
about 1.3 wt % copper;
about 0.45 wt % niobium;
about 0.01 wt % nitrogen;
about 0.3 wt % tantalum;
about 0.03 wt % aluminum;
about 0.01 wt % boron; and
iron.
4. The composition according to any preceding clause, wherein the composition comprises balance iron and residual elements.
5. The composition according to any preceding clause, wherein the composition exhibits a stress rupture duration of at least 25 hours when exposed to 62 ksi at 1050° F.
6. The composition according to any preceding clause, wherein the composition exhibits a stress rupture duration of at least 35 hours when exposed to 62 ksi at 1050° F.
7. The composition according to any preceding clause, wherein the composition exhibits a stress rupture duration of at least 40 hours when exposed to 62 ksi at 1050° F.
8. The composition according to any preceding clause, wherein the composition exhibits at least 8 Ft-lbs Charpy energy absorbed at room temperature.
9. The composition according to any preceding clause, wherein the composition exhibits at least 12 Ft-lbs Charpy energy absorbed at room temperature.
10. The composition according to any preceding clause, wherein the composition exhibits a stress rupture duration of at least 25 hours when exposed to 62 ksi at 1050° F. and at least 8 Ft-lbs Charpy energy absorbed at room temperature.
11. The composition according to any preceding clause, wherein the composition exhibits a stress rupture duration of at least 25 hours when exposed to 62 ksi at 1050° F. and at least 12 Ft-lbs Charpy energy absorbed at room temperature.
12. The composition according to any preceding clause, wherein the composition exhibits a stress rupture duration of at least 35 hours when exposed to 62 ksi at 1050° F. and at least 8 Ft-lbs Charpy energy absorbed at room temperature.
13. The composition according to any preceding clause, wherein the composition exhibits a stress rupture duration of at least 35 hours when exposed to 62 ksi at 1050° F. and at least 12 Ft-lbs Charpy energy absorbed at room temperature.
14. The composition according to any preceding clause, wherein the composition exhibits a stress rupture duration of at least 40 hours when exposed to 62 ksi at 1050° F. and at least 12 Ft-lbs Charpy energy absorbed at room temperature.
15. The composition according to any preceding clause, wherein the composition is a wrought composition, a forged composition, and/or a cast composition.
16. An article comprising a composition, the composition comprising:
from about 0.16 wt % to about 0.24 wt % carbon;
from about 0.4 wt % to about 0.8 wt % manganese;
from about 0.10 wt % to about 0.30 wt % silicon;
from about 9.5 wt % to about 11.0 wt % chromium;
from about 0.3 wt % to about 0.7 wt % nickel;
from about 2.0 wt % to about 2.8 wt % molybdenum;
from about 1.2 wt % to about 2.0 wt % tungsten;
from about 3.7 wt % to about 4.3 wt % cobalt;
from about 1.1 wt % to about 1.5 wt % copper;
from about 0.35 wt % to about 0.55 wt % niobium;
from about 0.005 wt % to about 0.025 wt % nitrogen;
from about 0.20 wt % to about 0.40 wt % tantalum;
from about 0.01 wt % to about 0.05 wt % aluminum;
from about 0.005 wt % to about 0.025 wt % boron; and
iron.
17. The article according to the preceding clause, wherein the composition is a wrought composition, a forged composition, and/or a cast composition.
18. The article according to any preceding clause, wherein the article is a component of a turbine selected from the group consisting of an inner casing for an in-case steam turbine high pressure rotor, an inner casing for an in-case steam turbine intermediate pressure rotor, an outer casing for an in-case steam turbine high pressure rotor, an outer casing for an in-case steam turbine intermediate pressure rotor, a packing head, a diaphragm casing, and a combination thereof.
19. The article according to any preceding clause, wherein the article is a component of a turbine selected from the group consisting of a nozzle, a shroud, a splash plate, a combustor component, a diffuser case, an inner diffuser case, a compressor case, an inner compressor case, a splitter, an inner barrel, a turbine shell, compressor blades, compressor vanes, guide vanes, retaining rings, and a combination thereof.
20. The article according to any preceding clause, wherein the composition exhibits at least 10 Ft-lbs Charpy energy absorbed at room temperature.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever. The starting material for the following Examples may not have necessarily been prepared by a particular preparative run whose procedure is described in other Examples. It also is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

### Example 1. Tested Compositions

One hundred and fifty (150) different iron-based alloy compositions were produced in the form of laboratory scale ingots and analyzed to determine their properties. These compositions and their corresponding properties were compared in these examples.

Select prepared compositions are shown in the below table. CE is a comparative iron-based alloy composition, while alloy compositions “36”, “61”, “79”, “144”, and “145” are numbered compositions that were made in production of the 150 different iron-based alloy compositions. The use of “<” indicates that the given element includes less than the given amount, but not that the given element is necessarily present.

TABLE 1
Tested compositions.

| | CE | 36 | 61 | 79 | 144 | 145 |
|---|---|---|---|---|---|---|
| Element | (wt %) | (wt %) | (wt %) | (wt %) | (wt %) | (wt %) |
| Carbon | 0.11 | 0.17 | 0.32 | 0.27 | 0.21 | 0.22 |
| Manganese | 0.44 | 0.43 | 0.62 | 0.67 | 0.62 | 0.41 |
| Silicon | 0.08 | 0.20 | 0.18 | 0.28 | 0.24 | 0.13 |
| Chromium | 10.26 | 7.88 | 8.30 | 9.02 | 10.35 | 10.40 |
| Nickel | 0.70 | 0.69 | 0.45 | 0.79 | 0.55 | 0.50 |
| Molybdenum | 1.05 | 2.14 | 0.97 | 0.21 | 2.42 | 1.51 |
| Tungsten | 0.96 | 2.35 | 2.10 | 3.73 | 1.64 | 1.45 |
| Cobalt | <0.01 | 4.03 | 3.29 | 2.20 | 4.20 | 0.99 |
| Copper | <0.01 | 0.99 | 1.30 | 0.64 | 1.35 | 1.00 |
| Vanadium | 0.21 | <0.01 | 0.48 | 0.13 | 0.34 | 0.26 |
| Niobium | 0.06 | 0.66 | 0.07 | 0.16 | 0.45 | 0.25 |
| Nitrogen | 0.03 | 0.01 | 0.02 | 0.01 | 0.01 | 0.03 |
| Aluminum | <0.01 | 0.11 | 0.01 | 0.07 | 0.03 | <0.01 |
| Titanium | <0.01 | 0.15 | 0.29 | 0.20 | <0.01 | <0.01 |
| Tantalum | <0.01 | 0.62 | 0.23 | 0.09 | 0.28 | 0.05 |
| Boron | <0.005 | 0.012 | 0.015 | 0.016 | 0.016 | <0.005 |
| Iron | Balance | Balance | Balance | Balance | Balance | Balance |
| Total | 100 | 100 | 100 | 100 | 100 | 100 |

### Example 2. Properties

Several properties of CE and alloys 36, 61, 79, 144, and 145 were analyzed and compared as follows.

Samples of each alloy were exposed to 1050° F. for 1,000 hours to evaluate the hardness stability. Rockwell C hardness measurements were taken before and after the exposure cycle. CE lost 7.8 points of Rockwell C (HRC) hardness during the test. In comparison, alloys 36 and 144, lost only 1.6 and 2.0 HRC points from the exposure. Alloy 145 lost 4.0 points while alloys 79 and 61 lost 6.1 and 7.5 HRC points, respectively. For reference, 1 point of HRC hardness correlates to approximately 2 ksi of tensile strength, which means that CE lost roughly 15 ksi of tensile strength from this exposure cycle. Prior to the test, all alloys were tempered to a target hardness of 35 HRC. Results are shown below in Table 2. Alloys 36 and 144 show the best hardness stability.

TABLE 2
Hardness stability.

| | Hardness Before | Hardness After | Change in |
|---|---|---|---|
| Alloy | Exposure (HRC) | Exposure (HRC) | Hardness (HRC) |
| CE | 35.57 | 27.79 | −7.78 |
| 36 | 35.09 | 33.46 | −1.63 |
| 61 | 36.13 | 28.63 | −7.50 |
| 79 | 36.66 | 30.57 | −6.09 |
| 144 | 36.21 | 34.20 | −2.01 |
| 145 | 36.49 | 32.51 | −3.98 |

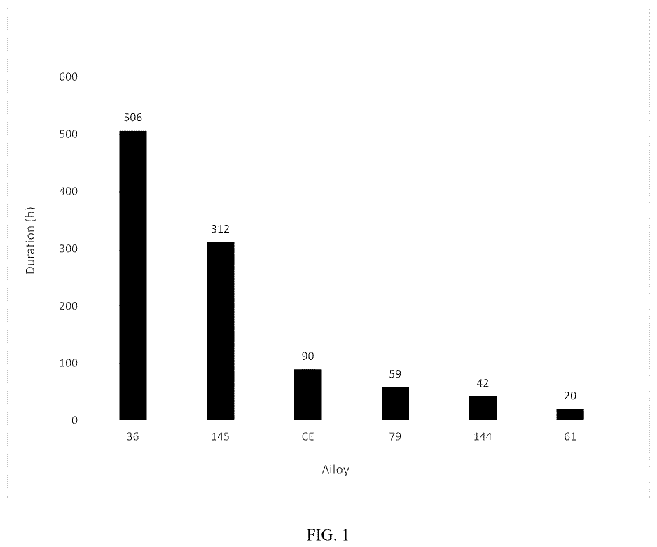

Stress rupture testing was performed on combination smooth and notched samples. The requirement for CE is 35 hours minimum at 62 ksi and 1050° F. FIG. 1 depicts that alloys 36 and 145 performed much better than CE in stress rupture. In addition, all the alloys except alloy 61 meet the minimum requirement.

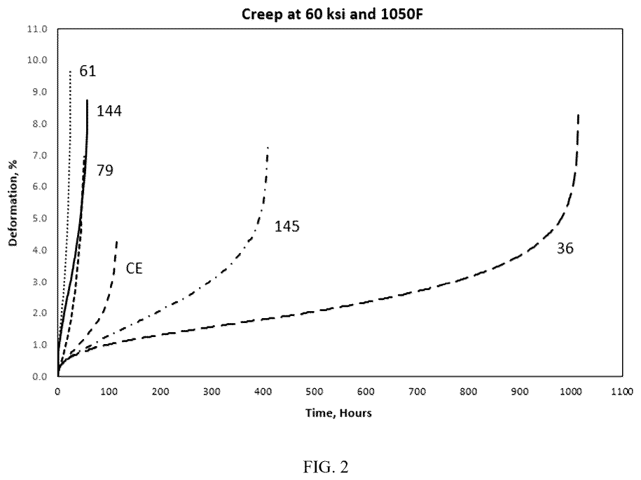

Creep testing was performed at 60 ksi and 1050° F. FIG. 2 depicts that alloys 36 and 145 show the best creep behavior at these conditions.

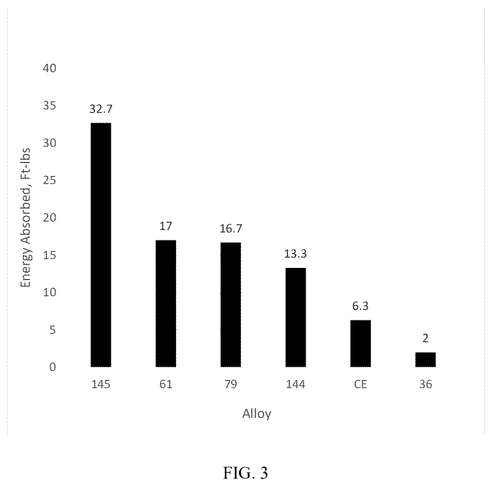

Charpy testing was also performed. The minimum requirement for Charpy Energy is 30 ft-lbs absorbed at room temperature. FIG. 3 depicts that only alloy 145 is above this minimum requirement. The significantly higher Charpy performance of alloy 145 was unexpected.

### Example 3. Inventive Alloy Composition Ranges

Based on the production, analysis, and comparison of the 150 different iron-based alloy compositions of these examples, inventive alloy compositions including ranges of elements were discovered, as shown in the following table. A value of “-” indicates that the given element is not included in the composition.

IE1 and IE2 are based on alloy 36. IE3 and IE4 are based on alloy 145. IE5 and IE6 are based on alloy 144.

TABLE 3
Inventive alloy composition ranges.

| | IE1 | IE2 | IE3 | IE4 | IE5 | IE6 |
|---|---|---|---|---|---|---|
| Element | (wt %) | (wt %) | (wt %) | (wt %) | (wt %) | (wt %) |
| Carbon | 0.12- | 0.15- | 0.20- | 0.22- | 0.16- | 0.18- |
| | 0.23 | 0.20 | 0.28 | 0.26 | 0.24 | 0.22 |
| Manganese | 0.2- | 0.30- | 0.30- | 0.40- | 0.40- | 0.50- |
| | 0.6 | 0.50 | 0.60 | 0.50 | 0.80 | 0.70 |
| Silicon | 0.1- | 0.15- | 0.05- | 0.05- | 0.1- | 0.15- |
| | 0.3 | 0.25 | 0.20 | 0.10 | 0.3 | 0.25 |
| Chromium | 7.0- | 7.5- | 10.0- | 10.0- | 9.5- | 10.0- |
| | 9.0 | 8.5 | 11.0 | 10.6 | 11.0 | 10.6 |
| Nickel | 0.5- | 0.6- | 0.30- | 0.40- | 0.30- | 0.40- |
| | 0.9 | 0.8 | 0.70 | 0.60 | 0.70 | 0.60 |
| Molybdenum | 1.8- | 2.0- | 1.35- | 1.45- | 2.0- | 2.2- |
| | 2.4 | 2.2 | 1.65 | 1.55 | 2.8 | 2.6 |
| Tungsten | 2.0- | 2.2- | 1.30- | 1.40- | 1.2- | 1.4- |
| | 2.6 | 2.4 | 1.60 | 1.50 | 2.0 | 1.8 |
| Cobalt | 3.5- | 3.9- | 0.85- | 0.95- | 3.7- | 3.8- |
| | 4.5 | 4.1 | 1.15 | 1.05 | 4.3 | 4.2 |
| Copper | 0.8- | 0.9- | 0.85- | 0.95- | 1.1- | 1.2- |
| | 1.2 | 1.1 | 1.15 | 1.05 | 1.5 | 1.4 |
| Vanadium | — | — | 0.20- | 0.23- | — | — |
| | | | 0.30 | 0.27 | | |
| Niobium | 0.5- | 0.6- | 0.25- | 0.26- | 0.35- | 0.40- |
| | 0.8 | 0.7 | 0.35 | 0.30 | 0.55 | 0.50 |
| Nitrogen | 0.005- | 0.005- | 0.05- | 0.05- | 0.005- | 0.005- |
| | 0.025 | 0.015 | 0.10 | 0.08 | 0.025 | 0.015 |
| Aluminum | 0.05- | 0.05- | — | — | 0.01- | 0.02- |
| | 0.20 | 0.15 | | | 0.05 | 0.04 |
| Titanium | 0.05- | 0.10- | — | — | — | — |
| | 0.25 | 0.20 | | | | |
| Tantalum | 0.4- | 0.55- | 0.03- | 0.04- | 0.20- | 0.25- |
| | 0.8 | 0.65 | 0.07 | 0.06 | 0.40 | 0.35 |
| Boron | 0.005- | 0.005- | — | — | 0.005- | 0.005- |
| | 0.025 | 0.015 | | | 0.025 | 0.015 |
| Iron | Balance | Balance | Balance | Balance | Balance | Balance |
| Total | 100 | 100 | 100 | 100 | 100 | 100 |

It was discovered herein that compositions according to the present disclosure could be used for wrought and cast alloys. Compositions according to the present disclosure are broadly applicable in applications requiring alloys possessing at least one of improved hardness stability, improved Charpy performance, and improved creep strength at higher operating temperatures.

### Definitions

As used herein, references to “example embodiment” or “one embodiment” or “some embodiments” of the present disclosure are not intended to be interpreted as excluding the existence of additional embodiments that also incorporate the recited features.

When introducing elements of various embodiments disclosed herein, the articles “a,” “an,” “the,” and “said” are intended to mean that there are one or more of the elements. The terms “comprising,” “including,” and “having” are intended to be inclusive and mean that there may be additional elements other than the listed elements. The term “comprising” may alternatively be read to mean “consisting of” or “consisting essentially of”.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

Although specific features of various embodiments of the invention may be shown in some drawings and not in others, this is for convenience only. Moreover, references to “some embodiments” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A composition comprising:
from about 0.20 wt % to about 0.28 wt % carbon;
from about 0.3 wt % to about 0.6 wt % manganese;
from about 0.05 wt % to about 0.20 wt % silicon;
from about 10.0 wt % to about 11.0 wt % chromium;
from about 0.3 wt % to about 0.7 wt % nickel;
from about 1.35 wt % to about 1.65 wt % molybdenum;
from about 1.3 wt % to about 1.6 wt % tungsten;
from about 0.85 wt % to about 1.15 wt % cobalt;
from about 0.85 wt % to about 1.15 wt % copper;
from about 0.25 wt % to about 0.35 wt % niobium;
from about 0.05 wt % to about 0.10 wt % nitrogen;
from about 0.03 wt % to about 0.07 wt % tantalum;
from about 0.20 wt % to about 0.30 wt % vanadium; and
iron.

2. The composition of claim 1, comprising:
from about 0.22 wt % to about 0.26 wt % carbon;
from about 0.4 wt % to about 0.5 wt % manganese;
from about 0.05 wt % to about 0.10 wt % silicon;
from about 10.0 wt % to about 10.6 wt % chromium;
from about 0.4 wt % to about 0.6 wt % nickel;
from about 1.45 wt % to about 1.55 wt % molybdenum;
from about 1.4 wt % to about 1.5 wt % tungsten;
from about 0.95 wt % to about 1.05 wt % cobalt;
from about 0.95 wt % to about 1.05 wt % copper;
from about 0.26 wt % to about 0.30 wt % niobium;
from about 0.05 wt % to about 0.08 wt % nitrogen;
from about 0.04 wt % to about 0.06 wt % tantalum;
from about 0.23 wt % to about 0.27 wt % vanadium; and
iron.

3. The composition of claim 1, comprising:
about 0.24 wt % carbon;
about 0.5 wt % manganese;
about 0.075 wt % silicon;
about 10.3 wt % chromium;
about 0.5 wt % nickel;
about 1.5 wt % molybdenum;
about 1.45 wt % tungsten;
about 1.0 wt % cobalt;
about 1.0 wt % copper;
about 0.28 wt % niobium;
about 0.065 wt % nitrogen;
about 0.05 wt % tantalum;
about 0.25 wt % vanadium; and
iron.

4. The composition of claim 1, wherein the composition comprises balance iron and residual elements.

5. The composition of claim 1, wherein the composition exhibits a stress rupture duration of at least 35 hours when exposed to 62 ksi at 1050° F.

6. The composition of claim 1, wherein the composition exhibits a stress rupture duration of at least 100 hours when exposed to 62 ksi at 1050° F.

7. The composition of claim 1, wherein the composition exhibits a stress rupture duration of at least 300 hours when exposed to 62 ksi at 1050° F.

8. The composition of claim 1, wherein the composition exhibits less than 5% creep deformation for at least 100 hours when exposed to 60 ksi at 1050° F.

9. The composition of claim 1, wherein the composition exhibits less than 5% creep deformation for at least 200 hours when exposed to 60 ksi at 1050° F.

10. The composition of claim 1, wherein the composition exhibits less than 5% creep deformation for at least 400 hours when exposed to 60 ksi at 1050° F.

11. The composition of claim 1, wherein the composition exhibits a hardness loss of less than 6 HRC when exposed to 1050° F. for 1000 hours.

12. The composition of claim 1, wherein the composition exhibits a hardness loss of less than 5 HRC when exposed to 1050° F. for 1000 hours.

13. The composition of claim 1, wherein the composition exhibits at least 15 Ft-lbs Charpy energy absorbed at room temperature.

14. The composition of claim 1, wherein the composition exhibits at least 25 Ft-lbs Charpy energy absorbed at room temperature.

15. The composition of claim 1, wherein the composition is a wrought composition, a forged composition, and/or a cast composition.

16. An article comprising a composition, the composition comprising:
from about 0.20 wt % to about 0.28 wt % carbon;
from about 0.3 wt % to about 0.6 wt % manganese;
from about 0.05 wt % to about 0.20 wt % silicon;
from about 10.0 wt % to about 11.0 wt % chromium;
from about 0.3 wt % to about 0.7 wt % nickel;
from about 1.35 wt % to about 1.65 wt % molybdenum;
from about 1.3 wt % to about 1.6 wt % tungsten;
from about 0.85 wt % to about 1.15 wt % cobalt;
from about 0.85 wt % to about 1.15 wt % copper;
from about 0.25 wt % to about 0.35 wt % niobium;
from about 0.05 wt % to about 0.10 wt % nitrogen;
from about 0.03 wt % to about 0.07 wt % tantalum;
from about 0.20 wt % to about 0.30 wt % vanadium; and
iron.

17. The article of claim 16, wherein the composition is a wrought composition, a forged composition, and/or a cast composition.

18. The article of claim 16, wherein the article is a component of a turbine selected from the group consisting of an inner casing for an in-case steam turbine high pressure rotor, an inner casing for an in-case steam turbine intermediate pressure rotor, an outer casing for an in-case steam turbine high pressure rotor, an outer casing for an in-case steam turbine intermediate pressure rotor, a packing head, a diaphragm casing, and a combination thereof.

19. The article of claim 16, wherein the article is a component of a turbine selected from the group consisting of a nozzle, a shroud, a splash plate, a combustor component, a diffuser case, an inner diffuser case, a compressor case, an inner compressor case, a splitter, an inner barrel, a turbine shell, compressor blades, compressor vanes, guide vanes, retaining rings, and a combination thereof.

20. The article of claim 16, wherein the composition exhibits at least 15 Ft-lbs Charpy energy absorbed at room temperature.
